(19) United States
(12) Patent Application Publication
(10) Pub. No.: US 2026/0321480 A1
(43) Pub. Date: Oct. 15, 2026

(54) INDUCTOR

(71) Applicant: ADVANTEST Corporation, Tokyo (JP)

(72) Inventor: Fumikazu TAKAYANAGI, Miyagi (JP)

(73) Assignee: ADVANTEST Corporation, Tokyo (JP)

(21) Appl. No.: 19/491,502

(22) PCT Filed: Mar. 14, 2024
(86) PCT No.: PCT/JP2024/009972

§ 371 Date: Dec. 9, 2025

(30) Foreign Application Priority Data
Jul. 26, 2023 (JP) 2023-121403

(51) Int. Cl. H01F 27/28; H01F 27/24

(52) U.S. Cl. CPC H01F 27/28; H01F 27/24

(57) ABSTRACT

An inductor includes a magnetic core and a coil. The magnetic core has an end face and a lateral side that intersects with the end face, and is formed as a film on a substrate. The coil is wound around the lateral side. The end face has a plurality of convex portions. The convex portions have a spacing smaller than a wavelength of an electromagnetic wave due to an eddy current generated at the end face. The convex portions have a depth greater than a predetermined depth at which a current density of the eddy current decays to a predetermined rate.

### TECHNICAL FIELD

The present invention relates to a magnetic core of an inductor.

### BACKGROUND ART

There have conventionally been known inductors with a coil wound around a thin magnetic core (see Patent Literatures 1 to 3, for example).

### CITATION LIST

### Patent Literature

Patent Literature 1: Japanese Patent Application Publication No. H07-249516

Patent Literature 2: Japanese Patent Application Publication No. 2020-155733

Patent Literature 3: Japanese Patent Application Publication No. 2013-258393

### SUMMARY OF THE INVENTION

### Technical Problem

Incidentally, such related arts as described above suffer from an eddy current generated in the magnetic core. To address this, powder-molding the magnetic core could reduce such an eddy current, but it is difficult to powder-mold the magnetic core if it is thin (particularly of what can be called a planar circuit).

It is hence an object of the present invention to reduce an eddy current that may be generated in a magnetic core of an inductor.

### Means for Solving the Problem

According to the present invention, an inductor includes: a magnetic core having an end face and a lateral side that intersects with the end face, the magnetic core formed as a film on a substrate; and a coil wound around the lateral side, wherein the end face has a plurality of convex portions, the convex portions have a spacing smaller than a wavelength of an electromagnetic wave due to an eddy current generated at the end face, and the convex portions have a depth greater than a predetermined depth at which a current density of the eddy current decays to a predetermined rate.

According to the thus constructed inductor, a magnetic core has an end face and a lateral side that intersects with the end face, and is formed as a film on a substrate. A coil is wound around the lateral side. The end face has a plurality of convex portions. The convex portions have a spacing smaller than a wavelength of an electromagnetic wave due to an eddy current generated at the end face. The convex portions have a depth greater than a predetermined depth at which a current density of the eddy current decays to a predetermined rate.

According to the inductor of the present invention, the predetermined depth may be a depth at which the current density of the eddy current is 1/e of the current density at the end face (where “e” represents a base of natural logarithm).

According to the inductor of the present invention, the spacing may have a constant value.

According to the inductor of the present invention, the spacing may have different values.

According to the inductor of the present invention, the convex portions may have a reduced width toward tip ends of the convex portions.

According to the inductor of the present invention, the convex portions may have a constant width.

According to the inductor of the present invention, some of the convex portions may have a reduced width toward tip ends of the convex portions, and others of the convex portions may have a constant width.

According to the inductor of the present invention, the convex portions may be arranged in a manner spaced in a width direction of the magnetic core.

According to the inductor of the present invention, the convex portions may be arranged in a manner spaced in a thickness direction of the magnetic core.

According to the inductor of the present invention, the magnetic core may be made of any one of permendur, FeNi, silicon steel, Ni, and CoFeSiB nanocrystalline material.

According to the inductor of the present invention, the magnetic core may be formed as a film by sputtering.

According to the inductor of the present invention, the magnetic core may be formed as a film by plating.

### BRIEF DESCRIPTION OF DRAWINGS

FIG. 1 is a plan view of an inductor 1 according to a first embodiment of the present invention;

FIG. 2 is a cross-sectional view taken along II-II in FIG. 1;

FIG. 3 is a left side view of the inductor 1 according to the first embodiment;

FIG. 4 is a plan view of an inductor 1 according to a second embodiment of the present invention;

FIG. 5 is a left side view of the inductor 1 according to the second embodiment;

FIG. 6 is a partially enlarged plan view in a vicinity of convex portions 4a1 of an inductor 1 according to a third embodiment;

FIG. 7(a) and 7(b) are a left side view (FIG. 7(a)) and a front view (FIG. 7(b)) of an inductor 1 according to a variation of the first embodiment;

FIG. 8(a) and 8(b) are a left side view (FIG. 8(a)) and a front view (FIG. 8(b)) of an inductor 1 according to a variation of the second embodiment;

FIG. 9(a) and 9(b) are a partially enlarged view (FIG. 9(a)) of the convex portions 4a1 with the spacing having a constant value “d” and a partially enlarged view (FIG. 9(b)) of the convex portions 4a1 with the spacing having different values d1, d2 in the first embodiment; and

FIG. 10(a) and 10(b) are a partially enlarged view (FIG. 10(a)) of the convex portions 4a1 with the spacing having a constant value “d” and a partially enlarged view (FIG. 10(b)) of the convex portions 4a1 with the spacing having different values d1, d2 in the second embodiment.

### MODES FOR CARRYING OUT THE INVENTION

A description will now be given of embodiments of the present invention referring to drawings.

### First Embodiment

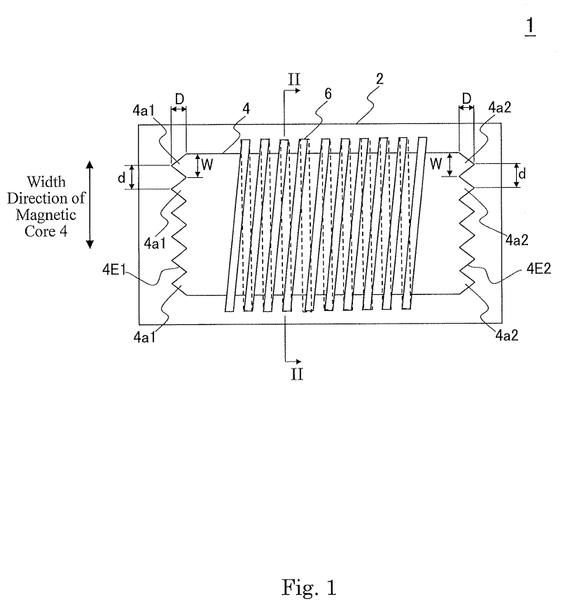

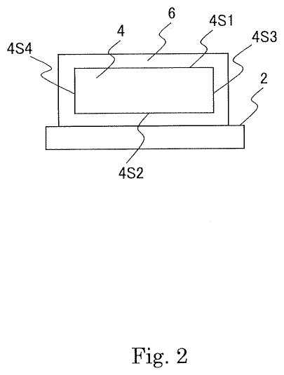

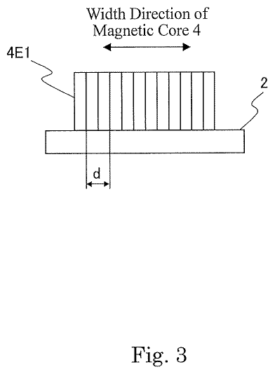

FIG. 1 is a plan view of an inductor 1 according to a first embodiment of the present invention. FIG. 2 is a cross-sectional view taken along II-II in FIG. 1. FIG. 3 is a left side view of the inductor 1 according to the first embodiment. Note here that no coil 6 is illustrated in FIG. 3.

The inductor 1 according to the first embodiment includes a magnetic core 4 and a coil 6.

The magnetic core 4 is formed as a film on a substrate 2. For example, the magnetic core 4 is formed as a film (with a thickness of 1 to 3 μm) by sputtering or as a film (with a thickness of 5 to 10 μm) by plating on the substrate 2. Also, the magnetic core 4 is made of any one of, for example, permendur, FeNi, silicon steel, Ni, and CoFeSiB nanocrystalline material.

The magnetic core 4 has end faces 4E1, 4E2 and lateral sides 4S1 to 4S4 that intersect with the end faces 4E1, 4E2 (see FIG. 2). It is noted that in FIG. 1, the end face 4E1 is at the left end of the magnetic core 4 and the end face 4E2 is at the right end of the magnetic core 4.

It is noted that in FIG. 2, the lateral side 4S1 is at the top of the magnetic core 4, the lateral side 4S2 is at the bottom of the magnetic core 4, the lateral side 4S3 is at the right of the magnetic core 4, and the lateral side 4S4 is at the left of the magnetic core 4.

The coil 6 is wound around the lateral sides 4S1 to 4S4. A current flowing through the coil 6 causes eddy currents to be generated at the end face 4E1 and the end face 4E2.

The end face 4E1 has multiple convex portions 4a1. The end face 4E2 has multiple convex portions 4a2.

The convex portions 4a1 have a spacing “d” smaller than the wavelength of an electromagnetic wave due to an eddy current generated at the end face 4E1. The convex portions 4a2 have spacing “d” smaller than the wavelength of an electromagnetic wave due to an eddy current generated at the end face 4E2. For example, the spacing “d” is within a range of 100 to 900 μm. The spacing “d” also has a constant value.

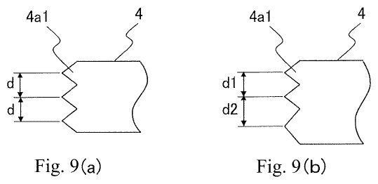

Note here that the spacing may not have a constant value “d”, but different values. FIG. 9(a) and 9(b) are a partially enlarged view (FIG. 9(a)) of the convex portions 4a1 with the spacing having a constant value “d” and a partially enlarged view (FIG. 9(b)) of the convex portions 4a1 with the spacing having different values d1, d2 in the first embodiment.

FIG. 1 corresponds to the case where the spacing has a constant value “d” (FIG. 9(a)) but may correspond to the case where the spacing has different values d1, d2 (FIG. 9(b)). It will be appreciated that the spacing may have three or more different values.

The convex portions 4a1 have a depth D greater than a predetermined depth at which the current density of an eddy current decays to a predetermined rate. The convex portions 4a2 have a depth D greater than a predetermined depth at which the current density of an eddy current decays to a predetermined rate. The predetermined depth is only required to have a value at which the current density of the eddy current is sufficiently low. For example, the predetermined depth is a depth at which the current density of the eddy current is 1/e of the current density at the end face 4E1 and the end face 4E2 (where “e” represents the base of natural logarithm).

It is noted that the convex portions 4a1 and the convex portions 4a2 have a reduced width W toward the tip ends of the convex portions 4a1, 4a2. It is also noted that the convex portions 4a1 and the convex portions 4a2 are arranged in a manner spaced in a width direction of the magnetic core 4.

Next will be described an operation according to the first embodiment.

If the convex portions 4a1 and the convex portions 4a2 were not provided, a current flowing through the coil 6 would cause electrons to transfer on the end face 4E1 and the end face 4E2 of the magnetic core 4 to result in eddy currents. However, since the convex portions 4a1 and the convex portions 4a2 are actually provided, electrons, even when trying to transfer on the end face 4E1 and the end face 4E2 of the magnetic core 4, are prevented from transferring by the convex portions 4a1 and the convex portions 4a2 and thereby less likely to cause eddy currents.

In accordance with the first embodiment, it is possible to reduce an eddy current that may be generated in the magnetic core 4 of the inductor 1.

It is noted that the first embodiment may include the following variation.

### Variation

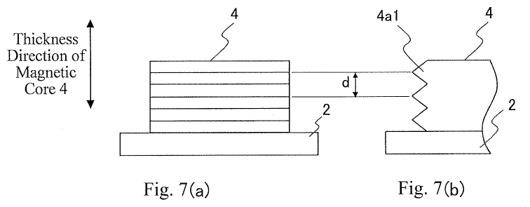

FIG. 7(a) and 7(b) are a left side view (FIG. 7(a)) and a front view (FIG. 7(b)) of an inductor 1 according to a variation of the first embodiment. Note here that no coil 6 is illustrated in FIG. 7(a). Note also that only the vicinity of convex portions 4a1 is illustrated in FIG. 7(b).

The inductor 1 according to the variation of the first embodiment has a configuration in which the convex portions 4a1 are arranged in a manner spaced in a thickness direction of the magnetic core 4. This variation also allows to exhibit the same advantageous effects as the first embodiment.

### Second Embodiment

A second embodiment provides an inductor 1 with convex portions 4a1, 4a2 having a constant width, which differs from the inductor 1 according to the first embodiment in which the convex portions 4a1, 4a2 have a reduced width toward the tip ends of the convex portions 4a1, 4a2.

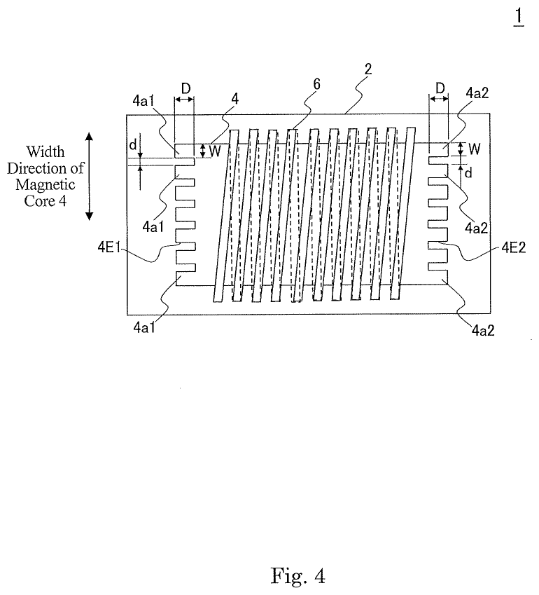

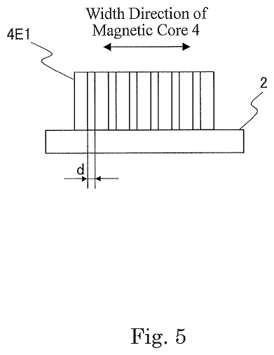

FIG. 4 is a plan view of the inductor 1 according to the second embodiment of the present invention. FIG. 5 is a left side view of the inductor 1 according to the second embodiment. Note here that no coil 6 is illustrated in FIG. 5.

The inductor 1 according to the second embodiment includes a magnetic core 4 and a coil 6. The magnetic core 4 has end faces 4E1, 4E2 and lateral sides 4S1 to 4S4 that intersect with the end faces 4E1, 4E2 (see FIG. 2). The coil 6 and the lateral sides 4S1 to 4S4 are identical to those in the first embodiment and will not be described.

The end face 4E1 has multiple convex portions 4a1. The end face 4E2 has multiple convex portions 4a2. The convex portions 4a1 and the convex portions 4a2 have a constant width. The convex portions 4a1 and the convex portions 4a2 are also arranged in a manner spaced in a width direction of the magnetic core 4. The configuration other than this is identical to that in the first embodiment and will not be described.

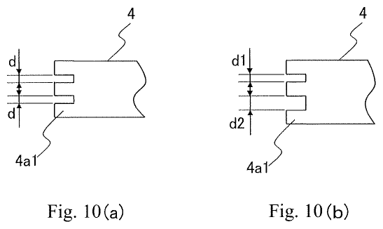

Note here that the spacing may not have a constant value “d”, but different values. FIG. 10(a) and 10(b) are a partially enlarged view (FIG. 10(a)) of the convex portions 4a1 with the spacing having a constant value “d” and a partially enlarged view (FIG. 10(b)) of the convex portions 4a1 with the spacing having different values d1, d2 in the second embodiment.

FIG. 4 corresponds to the case where the spacing has a constant value “d” (FIG. 10(a)), but may correspond to the case where the spacing has different values d1, d2 (FIG. 10(b)). It will be appreciated that the spacing may have three or more different values.

The operation according to the second embodiment is identical to that according to the first embodiment and will not be described.

In accordance with the second embodiment, it is possible to reduce an eddy current that may be generated in the magnetic core 4 of the inductor 1.

It is noted that the second embodiment may include the following variation.

### Variation

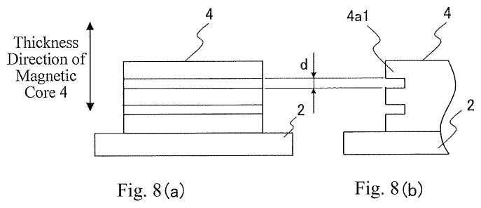

FIG. 8(a) and 8(b) are a left side view (FIG. 8(a)) and a front view (FIG. 8(b)) of an inductor 1 according to a variation of the second embodiment. Note here that no coil 6 is illustrated in FIG. 8(a). Note also that only the vicinity of convex portions 4a1 is illustrated in FIG. 8(b).

The inductor 1 according to the variation of the second embodiment has a configuration in which the convex portions 4a1 are arranged in a manner spaced in a thickness direction of the magnetic core 4. This variation also allows to exhibit the same advantageous effects as the second embodiment.

### Third Embodiment

A third embodiment provides an inductor 1 including convex portions 4a1, 4a2 with some having a constant width and the others having a reduced width toward the tip ends of the convex portions 4a1, 4a2, which differs from the inductors 1 according to the first embodiment and the second embodiment.

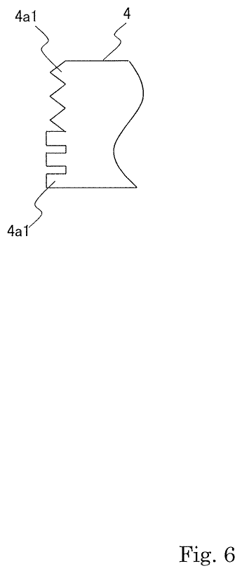

FIG. 6 is a partially enlarged plan view in the vicinity of the convex portions 4a1 of the inductor 1 according to the third embodiment.

The inductor 1 according to the third embodiment includes convex portions 4a1 with some (the upper three convex portions 4a1) having a reduced width toward the tip ends of the convex portions 4a1 (see First Embodiment) and the others (the lower three convex portions 4a1) having a constant width (see Second Embodiment). The configuration other than this is identical to that in the first embodiment and will not be described.

The operation according to the third embodiment is identical to that according to the first embodiment and will not be described.

In accordance with the third embodiment, it is possible to reduce an eddy current that may be generated in the magnetic core 4 of the inductor 1.

### DESCRIPTION OF REFERENCE NUMERAL

1 Inductor
2 Substrate
4 Magnetic Core
4E1, 4E2 End Face
4a1, 4a2 Convex Portion
4S1 to 4S4 Lateral Side
6 Coil
W Width of Convex Portion
d, d1, d2 Spacing between Convex Portions
D Depth of Convex Portion

1. An inductor comprising:
a magnetic core having an end face and a lateral side that intersects with the end face, the magnetic core formed as a film on a substrate; and
a coil wound around the lateral side, wherein
the end face has a plurality of convex portions,
the convex portions have a spacing smaller than a wavelength of an electromagnetic wave due to an eddy current generated at the end face, and
the convex portions have a depth greater than a predetermined depth at which a current density of the eddy current decays to a predetermined rate.

2. The inductor according to claim 1, wherein
the predetermined depth is a depth at which the current density of the eddy current is 1/e of the current density at the end face (where “e” represents a base of natural logarithm).

3. The inductor according to claim 1, wherein
the spacing has a constant value.

4. The inductor according to claim 1, wherein
the spacing has different values.

5. The inductor according to claim 1, wherein
the convex portions have a reduced width toward tip ends of the convex portions.

6. The inductor according to claim 1, wherein
the convex portions have a constant width.

7. The inductor according to claim 1, wherein
some of the convex portions have a reduced width toward tip ends of the convex portions, and
others of the convex portions have a constant width.

8. The inductor according to claim 1, wherein
the convex portions are arranged in a manner spaced in a width direction of the magnetic core.

9. The inductor according to claim 1, wherein
the convex portions are arranged in a manner spaced in a thickness direction of the magnetic core.

10. The inductor according to claim 1, wherein
the magnetic core is made of any one of permendur, FeNi, silicon steel, Ni, and CoFeSiB nanocrystalline material.

11. The inductor according to claim 1, wherein
the magnetic core is formed as a film by sputtering.

12. The inductor according to claim 1, wherein
the magnetic core is formed as a film by plating.
